(19) United States
(12) Patent Application Publication
(10) Pub. No.: US 2009/0030578 A1
(43) Pub. Date: Jan. 29, 2009

(54) METHOD AND DEVICE FOR DETECTING AND CLASSIFYING THE POSITION OF AN OCCUPANT OF A VEHICLE SEAT

(75) Inventors: Stephanie PERIOT, Paris (FR); Jean-Marc POINSIGNON, Fouligny (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/829,730

(22) Filed: Jul. 27, 2007

(51) Int. Cl. B60N 2/24

(52) U.S. Cl. 701/49

(57) ABSTRACT

The seat has at least one displacement adjustment controlled by at least one actuator.

The method includes the following steps:
a) said actuator enabling the displacement of said seat is controlled (400) by progressively increasing with time the power supplied (PA) to said actuator following a predetermined profile,
b) the startup (D_{M}) movement of the displacement actuator is detected, and the value of said power is recorded at that moment,
c) said recorded power value is compared to a series of predetermined reference values in order to determine the presence of an occupant on the seat (1) and classify him according to his weight.
Motor vehicle safety, comfort and vision systems.

The present invention concerns a method and a device for occupant detection and classification for a vehicle seat, in particular a motor vehicle seat. The method and the device of the invention pertain firstly to detecting the presence of an occupant on a vehicle seat, but also to classifying the occupant of an occupied seat according to his weight, that is, determining whether the occupant is a child or an adult, and into which weight range the adult falls.

According to PCT patent No. WO 98/41424, a device is known for controlling the activation of an airbag system in a motor vehicle. The passenger seat of the vehicle has a frame and a string network attached to the frame to support the weight of an occupant on the seat. The device includes a sensor coupled to a part of the string network in order to measure a tensile stress exerted on the network by the weight of the seat occupant and to send a signal representing this stress. There is also a computer connected to the sensor output that produces an airbag deployment control signal when the tensile stress reaches a predetermined threshold value.

The use of pressure sensing layers integrated into the inner padding of seats to detect the presence of a passenger is also known. Each of the sensors modifies its electrical resistance as a function of the pressure on it. These data then enable a measurement system to calculate a pressure profile, automatically correcting for the effects of the vehicle movement and the changes in position of the person sitting on the seat.

Such systems known to prior art entail considerable integration constraints (comfort, design, etc.) and a cost added to the vehicle. Moreover, these systems do not distinguish between various types of occupation, and thus cannot classify the occupant according to various categories.

A first purpose of the present invention is to devise a method and a device for occupant detection and classification for a vehicle seat that makes it possible to eliminate the current detection layers without adding a weight sensor.

A second purpose of the present invention is to devise a method and a device for occupant detection and classification for a seat that makes it possible to adjust the deployment strategies for the restraining means in an accident, for example, without affecting the passenger comfort settings. Note that other applications involving the weight of the occupant are targeted, particularly occupant recognition applications for the comfort settings, including, for example, occupant recognition for seat adjustment, for the massage or air conditioning function, changing the vehicle attitude and adjusting the lights or shock absorbers according to the weight of the occupants, mechanical diagnosis by kinematic readings (autodiagnosis of the seat based on wear), etc.

Another purpose of the present invention is to make such a device dependable and inexpensive.

In order to achieve these goals, the present invention implements a new method for occupant detection and classification for a vehicle seat, which seat has at least one displacement adjustment controlled by at least one displacement actuator. This new method includes the following steps:
a) said actuator enabling the displacement of said seat is controlled by progressively increasing with time the power supplied to said actuator using a predetermined profile,
b) the initial movement of the displacement actuator is detected, and the value of said power is recorded at that moment,
c) said recorded power value is compared to a series of predetermined reference values in order to determine the presence of an occupant on the seat and classify him according to his weight.

Note that the actuator can be an electric actuator, for example, a rotary or linear motor, or a pneumatic or analog actuator.

It is preferable to achieve said increase with a power control means.

It is also preferable to perform said increase following a linear-type profile.

It is also preferable that said increase follow a profile adjusted for previous measurement(s).

According to a particular embodiment of the invention, the variable characteristic is the cyclical ratio of a chopped voltage, but any other method known per se of varying power supplied to the actuator can be applied.

According to a preferred embodiment of the invention, prior to steps a) to c) of said method, an adequate is performed to take up the mechanical slack in the seat, or as a variant, an action is performed that makes it possible to not include the mechanical slack in the measurement.

Also according to the preferred embodiment of the invention, the method is repeated on a periodic and/or event basis in view of determining the presence of an occupant and his classification at each moment.

The method according to the invention is applied with such modifications as are necessary to the detection and classification by weight of an object in lieu of an occupant on the vehicle seat.

According to a preferred embodiment of the invention, after step c), a reverse action of said actuator is performed in order to cancel the changes in said seat adjustment.

Said displacement adjustment controlled by at least one displacement actuator can be a translational displacement adjustment of the seat or a rotary displacement adjustment of the seat, or a combination of the two.

Preferably, steps a) to c) are carried out when no seat command is activated, so as not to interfere with the measurement and to give priority use to the occupant.

In order to achieve the previously cited goals, and implement the method defined above, the present invention produces a new device for occupant (or object) detection and classification for a vehicle seat, which seat has at least one displacement adjustment controlled by at least one displacement actuator. This new device includes:
a) means for applying a predefined power profile to said displacement actuator for said seat, with said power having at least one characteristic representing the effort applied to the actuator.
b) means for detecting the movement of said seat actuator,
c) means for comparing said power value, defined at the moment said actuator moves, with a series of predetermined reference values for said power, in order to determine the presence of an occupant (or an object) on the seat and to classify it according to its weight.

Said means for applying a predefined power profile to said displacement actuator of said seat is preferably means for controlling the power supplied to said actuator.

Also, preferably, said means for applying a predefined power profile to said displacement actuator for said seat is a computer on board the vehicle.

According to a preferred embodiment of the invention, said computer is the means for detecting the movement of said seat actuator, and is also the means for comparing said value of the characteristic measured at the moment said actuator starts with a series of predetermined reference values for said characteristic.

Also according to a preferred embodiment of the invention, the actuator is an electric motor, preferably a rotary electric motor.

Other advantages and characteristics of the invention will appear in the following description of a preferred, non-limiting mode of embodiment of the object and scope of the present patent application, accompanied by drawings in which:

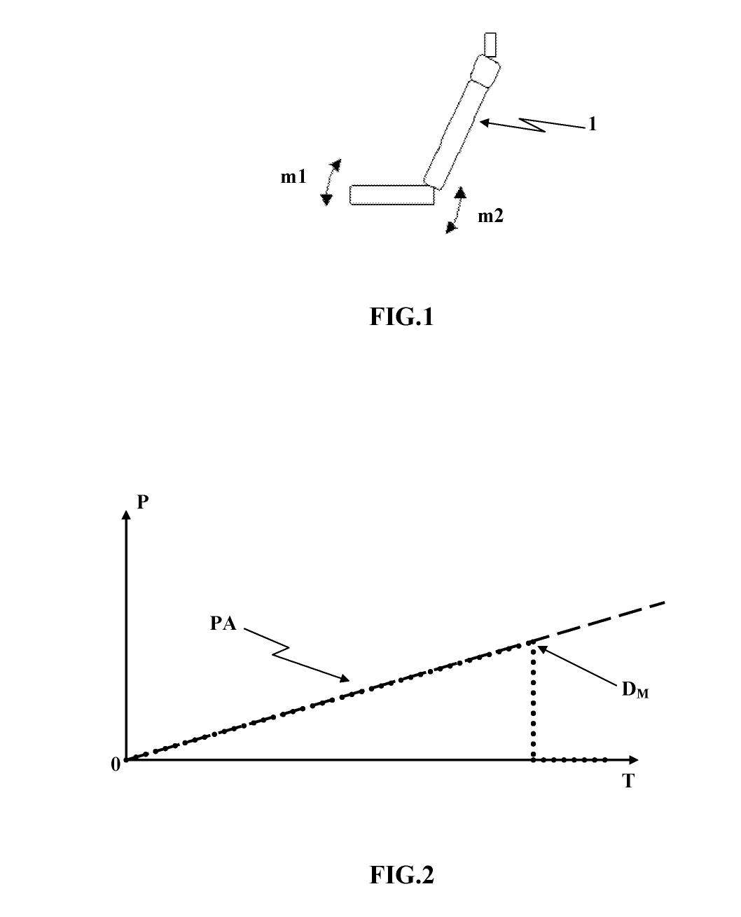

FIG. 1 is a schematic view of a vehicle seat,

FIG. 2 is an example of a graph representing a command profile for the seat adjustment actuators according to the invention,

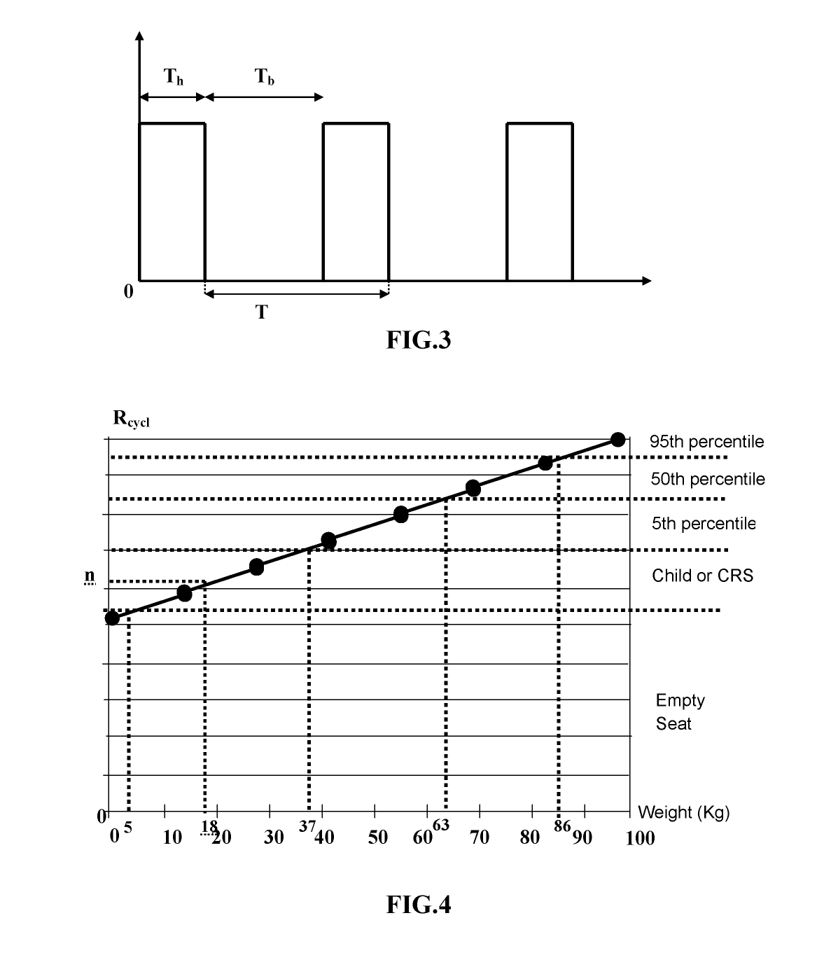

FIG. 3 represents a chopped voltage,

FIG. 4 is a graph of the power levels that enable the actuator to start, according to the weight applied, used to determine classification thresholds,

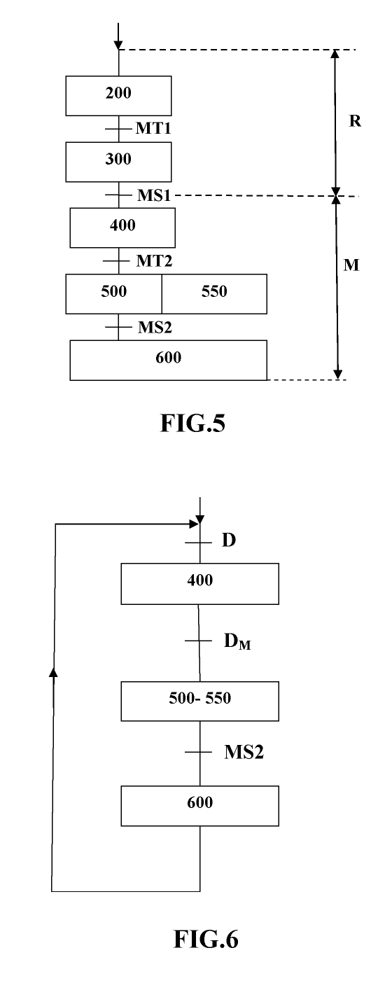

FIG. 5 is a general algorithm of the principle of measurement according to the invention,

FIG. 6 is an algorithm of the actual measurement according to the invention, A preferred embodiment of the present invention is described below.

At the outset, occupant classes were defined according to weight in a manner known per se. The thresholds of this classification match those in the following table:

| | Mass (in kg) | | | | |
|---|---|---|---|---|---|
| | 0 to 5 | 5 to 37 | 37 to 63 | 63 to 86 | >86 |
| Class | Seat | Child in CRD | 5^{th} | 50^{th} | 95^{th} |
| or | Empty | or | percentile | percentile | percentile |
| S/Group | | Booster seat | | | |

A percentile represents the percentage of individuals who weigh less than a given mass. Thus, 95% of individuals weigh less than 86 kg. According to the thresholds given above, the seat is considered empty for a weight between 0 and 5 kg. The seat is considered to be occupied by a child or a child in a CRD (child restraint device) or in a booster seat.

In FIG. 1, a seat 1 is schematically represented that can be adjusted, for example, by a vertical displacement m1 or a vertical movement of the booster seat m2.

The occupant detection and classification operation for the seat 1 includes two different time intervals: a first interval R, during which a compensation is made for the mechanical slack in the seat 1, and a second interval M, during which the actual measurement is taken (see FIG. 5).

In order to take the actual measurement, the vertical adjustment actuator(s) for the seat 1 is (are) energized using a power profile PA (FIG. 2) defined by an electronic computer not shown in the figure, where T is the time interval and P the power supplied to the actuator.

The instruction sent by the computer is a chopped voltage. Note that any other method of varying power supplied to the actuator can be applied. As indicated by its name, the voltage is chopped into a series of periodic rectangles (see FIG. 3). These rectangles are separated by a period T. Each period T is broken down into two parts: an interval at high power Th and an interval at low power Tb. The cyclical ratio R_{CYC} is the ratio between the time spent at high power Th and the period, and thus:

R_{CYC}=Th/T=Th/(Th+Tb)

The cyclical ratio is always less than 1, and is expressed as 0.5 if Th=Tb, or as 50%.

The chopped voltage is smoothed by the actuator coil in a manner known per se. An average voltage is obtained whose value depends on the cyclical ratio. Therefore, the variation in the cyclical ratio R_{CYC} will be reflected in the smoothed, average voltage.

As soon as the startup of the actuator is detected (point D_{M} on FIG. 2), the cyclical ratio at this precise instant R_{CYC} (Start) is recorded, and the occupant class or subgroup is identified according to the predefined thresholds, such as those seen on the graph in FIG. 4, which relates the cyclical ratio values recorded at actuator startup to the weight applied. The graph in FIG. 4 is obtained with preliminary measurements, and the resulting classification thresholds are integrated into the electronic computer.

The method according to the invention can also be described by the algorithm shown in the drawing in FIG. 5.

First, a compensation is made for the mechanical slack R.

In phase 200, the actuator is activated. The actuator is in motion or rotating (phase reference MT1), and is stopped (phase 300) when said compensation is finished. In the phase labeled MS1, the actuator is held pre-tensioned to prevent any motor reversal along with the loss of the pretensioning.

Then the actual measurement, labeled M, is begun.

In phase 400, the seat adjustment actuators are energized using the power profile PA and, as indicated above, the cyclical ratio begins to vary (also known as the PWM measurement, or Pulse Width Modulation). As soon as the actuator begins to move (phase MT2), the actuator is stopped (phase 500), and simultaneously (phase 550), the value of the cyclical ratio at the moment the actuator started is memorized. This value of R_{CYC} is called R_{CYC} (Start), and is sent to the computer (in phase 600) to be compared to the occupant classification thresholds in FIG. 4.

To give an example, as can be seen in the drawing in FIG. 4, if R_{CYC} (Start)=n on the ordinate axis of the graph, this value corresponds to a value of approximately 18 on the abscissa axis, and consequently represents a seat occupant weighing between 5 and 37 kg, therefore a child in a child restraint device or a booster seat.

During the so-called actual measurement phase M, the seat adjustment controls are deactivated so as to not interfere with the results.

In FIG. 6, the measurement algorithm itself is shown. A new measurement request is symbolized by D. In phase 400, the application of the power profile is begun, and the pulse counter starts. The moment the actuator starts is represented by D_{M}. At the moment the actuator stop phase occurs (reference 500) and at the end of memorization (reference 550) of the corresponding cyclical ratio value R_{CYC} (Start), the counter stops on this value and the power is reset to a certain value that makes it possible to hold the actuator pre-tensioned. Next, the actuator is stopped (phase reference MS2), and then the comparison is made between R_{CYC} (Start) and the thresholds in FIG. 4.

As previously indicated, in order to achieve a precise and dependable detection and classification result, all of the mechanical slack in the seat must be taken up before taking the actual measurement. As soon as the rotation of the actuator is detected, the actuator is stopped so as to not change the passenger comfort settings. Electrical seat actuators have a nominal speed of approximately 3000 rpm. If the rotation of the actuator is detected in one complete revolution (at most), and if the measurement takes two revolutions, including one to take up slack and one for detection), then the time period during which the actuator is activated is approximately (60/3000)×2=0.04 seconds, which makes the movement of the seat practically imperceptible to the passenger. If it is desired to decrease the measurement time, it is possible to detect the movement of the actuator by analyzing the current. This way, it is not necessary for the actuator to reach a sensor position in order to detect its movement.

Note that the manner in which the above-described measurement is taken is controlled according to detection/classification needs. This measurement can be taken on a periodic or event basis. In this way, a system has been devised that is useful and accommodates any detection strategy, as well as any type of displacement actuator. In each case, it is a matter of changing the detection and classification thresholds in the algorithm.

Note also that in order to steer clear of the potential edge effects of the seat and to avoid taking measurements when the seat is abutting a stop, software stops must be defined before the mechanical stops of the seat. This way, we ensure that all measurements are taken in identical conditions, regardless of the initial position of the seat.

Note also that of the many parameters involved in actuator fault thresholds, the primary ones are battery voltage, temperature, and aging of the actuator and the seat linkages. Consequently, it is helpful to monitor these parameters and to perform autocalibration sequences over the whole life of the device.

The device for implementing the method according to the invention includes:
means for applying a predefined power profile PA, represented in FIG. 2, to the seat 1 displacement actuator,
means for detecting said seat actuator startup D_{M}, effected by this power profile,
means for measuring the value of said variable power characteristic at each moment, which, in the present preferred embodiment of the invention, is the cyclical ratio R_{CYC} of the chopped command voltage.
means for comparing said value R_{CYC}, measured at the moment when the actuator starts R_{CYC} (Start), with a series of predetermined reference values for R_{CYC} according to weight, as can be seen on the graph in FIG. 4, so as to determine the presence of an occupant (or an object) on the seat and to detect and/or classify said occupant (or said object) according to its weight.

The means used to apply a predefined power profile to the seat displacement actuator is means for generating a chopped voltage with a variable cyclical ratio.

This power profile is defined by an electronic computer on board the vehicle. This computer is also the means for detecting the startup D_{M} of the seat actuator.

The same electronic computer is the means for comparing R_{CYC} (start) with a series of predetermined reference values for R_{CYC} according to weight.

The above-described method and device provide real advantages for vehicles equipped with electrical seats. The latter need few hardware and software modifications, because the current computers can be used to control the seat actuators and perform occupant detection/classification.

Since the detection and classification thresholds are adjusted at the software level, as previously mentioned, no external intervention is required, even during the production phase.

Adjusting the detection thresholds makes it possible to adapt the various strategies for the airbag to the conditions of use:
activation/deactivation
activation/low risk deployment
activation/low risk deployment/deactivation

This measurement is also provided to every device for which the present occupant's weight data is useful (comfort adjustment, air conditioning, etc.).

1. Method for occupant detection and classification for a vehicle seat, which seat has at least one displacement adjustment controlled by at least one displacement actuator, which includes the following steps:
a) said actuator enabling the displacement of said seat is controlled by progressively increasing with time the power supplied to said actuator using a predetermined profile,
b) the startup movement of the displacement actuator is detected, and the value of said power is recorded at that moment,
c) said recorded power value is compared to a series of predetermined reference values in order to determine the presence of an occupant on the seat and classify him according to his weight.

2. Method according to claim 1, wherein said increase is achieved with a power control means.

3. Method according to claim 1, wherein said increase is performed following a linear profile.

4. Method according to claim 1, wherein said increase follows a customized profile adjusted for previous measurement(s).

5. Method according to claim 1, wherein prior to steps a) to c) of said method, an adequate action is performed to take up the mechanical slack in the seat.

6. Method according to claim 1, wherein prior to steps a) to c) of said method, an action is performed making it possible to not take into account the mechanical slack in the measurement.

7. Method according to claim 1, which is repeated on a periodic and/or event basis in view of determining the presence of an occupant and his classification at each moment.

8. Method according to claim 1, wherein after step c), a reverse action of said actuator is additionally performed in order to cancel the changes in said seat adjustment.

9. Method according to claim 1, wherein said displacement adjustment controlled by at least one displacement actuator is a translational displacement adjustment of the seat.

10. Method according to claim 1, wherein said displacement adjustment controlled by at least one displacement actuator is a rotary displacement adjustment of the seat.

11. Method according to claim 1, wherein said displacement adjustment controlled by at least one displacement actuator is a displacement adjustment of the seat made up of a translational displacement of the seat and a rotary displacement of the seat.

12. Method according to claim 1, wherein steps a) to c) are carried out when no seat command is activated, so as not to interfere with the measurement and to give priority use to the occupant.

13. Method according to claim 1, which applies to the detection and classification according to weight of an object on said vehicle seat.

14. Device for occupant detection and classification for a vehicle seat, which seat has at least one displacement adjustment controlled by at least one displacement actuator, which includes:
a) means for applying a predefined power profile to said displacement actuator for said seat, with said power providing at least one characteristic representing the effort applied to the actuator.
b) means for detecting the movement of said seat actuator,
c) means for comparing said power value, defined at the moment said actuator moves, with a series of predetermined reference values for said power, in order to determine the presence of an occupant (or an object) on the seat and to classify it according to its weight.

15. Device according to claim 14, wherein said means for applying a predefined power profile to said displacement actuator of said seat is means for controlling the power supplied to said actuator.

16. Device according to claim 14, wherein said means for applying a predefined power profile to said displacement actuator for said seat is a computer on board the vehicle.

17. Device according to claim 16, wherein said computer is also the means for detecting the movement of said seat actuator.

18. Device according to claim 16, wherein said computer is also the means for comparing said value of the characteristic measured at the moment said actuator starts with a series of predetermined reference values for said characteristic.
